(19) United States
(12) Patent Application Publication
(10) Pub. No.: US 2007/0221083 A1
(43) Pub. Date: Sep. 27, 2007

(54) PRINTING PLATE MATERIAL, MANUFACTURING METHOD OF THE SAME, AND PLATE-MAKING METHOD USING THE SAME

(75) Inventors: Chiaki OHIGASHI, Kanagawa (JP); Shigeru IEMURA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/683,558

(22) Filed: Mar. 8, 2007

(30) Foreign Application Priority Data
Mar. 23, 2006 (JP) 2006-080295
Oct. 19, 2006 (JP) 2006-285532

(51) Int. Cl. B41N 3/00

(52) U.S. Cl. 101/463.1

(57) ABSTRACT

A printing plate material for direct plate making includes an aluminum base material, a hydrophilic layer provided on the base material, and a dot control layer provided on the hydrophilic layer and having a critical surface tension equal to or lower than a surface tension of the image forming liquid. An image forming liquid is discharged from an inkjet recording head onto the printing plate material for direct plate making and is hardened. Thereby, a direct-made printing plate is obtained.

### BACKGROUND OF THE INVENTION

1. Field of the Invention

The present invention relates to a printing plate material for direct plate making, a manufacturing method of the same, and a method for making a direct-made printing plate using the same, the direct-made printing plate being made of the printing plate material for direct plate making, on which an image forming liquid is selectively discharged according to a predetermined image pattern, and thereby an image portion is formed.

2. Description of Related Art

Conventional planographic printing employs an aluminum-based PS plate having a photosensitive resin layer (an image forming layer) evenly coated on a surface thereof. Making a printing plate using such a PS plate generally includes a number of processes, including an image forming process, a developing process, a washing process, a gumming process, a drying process, and the like (e.g., Related Art 1). In the image forming process, the PS plate is exposed to a laser according to a predetermined image pattern, so that an image portion is selectively hardened. The developing process develops the image using a developer. The washing process washes away the developer, an unnecessary photosensitive resin, and the like. The gumming process applies a liquid containing gum arabic, a starch derivative, or the like, in order to protect the surface of the PS plate.

Instead of the above-described plate-making method, recently proposed are a variety of technologies related to a method for making an offset printing plate in an inkjet system, which requires no such processes of developing, washing, and the like. Related Art 2 discloses, for example, a method for making a printing plate that includes a process for forming an image portion on a printing plate material base for planographic printing in the inkjet system, by using a photopolymerized ink composition having a photopolymerized composition; and a process for hardening the image portion formed of the ink composition, by exposing a surface of the base on which the image portion is formed to a light having a light emitting line in a wavelength range to which the ink composition is sensitive. In the method, however, it is difficult to control spread of the photopolymerized ink composition discharged on the printing plate material base for planographic printing in the inkjet system, and thus high resolution cannot be ensured. The method also has a problem where it is difficult to ensure dampening water retainability on a non-image portion. The dampening water retainability is important for printability, which is a property related to prevention of ink smear on the non-image portion, reduction in waste paper at an initial printing stage, prevention of a trouble at a restart of printing, and the like.

To address the above-described problems, Related Art 3 discloses a plate material for planographic printing and a method for making a planographic printing plate. The plate material has a flexible base provided thereon with an image receptive layer having receptivity to a thermofusible compound which is included in hot-melt ink. In the plate-making method using the plate material, hot-melt ink is recorded in an inkjet recording system, and then a portion of the image receptive layer exclusive of a portion on which the hot-melt ink is recorded, is etched with an etching solution for hydrophilization. Further, Related Art 4 discloses a technology wherein: a printing plate material for planographic printing is used, the printing plate material having a water-resistant base provided thereon with an image receptive layer that contains zinc oxide and a binding resin and that has a contact angle of 50 degrees or larger with respect to water; an image is formed in a hot-melt inkjet system on a surface of the image receptive layer; and a non-image portion on the image receptive layer is etched, so as to make a planographic printing plate. In the technologies disclosed in Related Arts 3 and 4, a minute amount of the sprayed hot-melt ink quickly hardens when contacting the planographic printing plate having a high heat capacity, thus preventing the spread of the hot-melt ink. The methods, however, require a heater and a temperature controller for a hot-melt ink composition and an inkjet recording head, and thus have a shortcoming that complicates an apparatus structure. Further, the hot-melt ink composition, which is easily liquidized by heat, is weak in strength as a solid object, thus making the printing plate unsuitable for mass printing.

As a method to further improve printability, Related Art 5 discloses a printing plate material used in a prepress apparatus for offset printing, the printing plate material requiring no alkaline developer, having high discrimination between image and non-image areas, and providing a quality printed image. The printing plate material is provided on a surface thereof with a thin layer including titanium oxide, zinc oxide, and the like as main components. An active light irradiated from an active light irradiator of the prepress apparatus onto the entire surface hydrophilizes the surface. A thermal recorder then forms an image in heat mode. Thereby, the non-image and image areas are formed on the plate material, the non-image area being exposed to the active light and having a hydrophilic property, the image area carrying the image and having a lipophilic property. In the method, however, thermal transfer in a lateral direction when the image is formed in the heat mode causes ink bleeding. In addition, the method has a problem, such as where heat mode using a laser requires a high power laser, and thus increases cost of the prepress apparatus. Meanwhile, using a heater element, such as a thermal head and the like, requires contact between the plate and the heater element. The contact causes wear between the plate and the heater element, thus not for practical use.
[Related Art 1] Japanese Patent Laid-open Publication H10-83082
[Related Art 2] Japanese Patent Laid-open Publication H05-204138
[Related Art 3] Japanese Patent Laid-open Publication H09-58144
[Related Art 4] Japanese Patent Laid-open Publication H10-58669
[Related Art 5] Japanese Patent Laid-open Publication H11-123807

As described above, the conventional printing plate materials and the plate-making methods using the same have the problems where it is difficult to provide a printing plate having printability represented as printing durability and dampening water retainability, and, at the same time, achieving a high-resolution image portion.

### SUMMARY OF THE INVENTION

The present invention is provided to address the problems in the conventional arts. The present invention provides a printing plate material for direct plate making on which an image forming liquid is discharged and directly attached to the a printing plate material so as to form an image portion; the printing plate material achieving high resolution while having a relatively simple structure, having excellent printability and printing durability, and being used for making a direct-made printing plate. The present invention further provides a manufacturing method of the printing plate material for direct plate making and a method for making a direct-made printing plate using the printing plate material for direct plate making.

The present invention has been reached based on the inventors' keen examination focusing on a relationship between surface tension of an image forming liquid and critical surface tension of a printing plate material for direct plate making. More specifically, the above-described purpose is achieved with a printing plate material for direct plate making described below in (1) to (18).

(1) A printing plate material for direct plate making on which an image forming liquid is selectively discharged and thereby an image portion is formed, the printing plate material for direct plate making comprising a base material, e.g. an aluminum base material, a hydrophilic layer provided on the base material, and a dot control layer provided on the hydrophilic layer and having a critical surface tension equal to or lower than a surface tension of the image forming liquid.

(2) The printing plate material for direct plate making according to (1), wherein the hydrophilic layer includes a photocatalyst that induces hydrophilization when being exposed to

(3) The printing plate material for direct plate making according to one of (1) and (2), wherein the hydrophilic layer includes an inorganic coating agent and titanium oxide.

(4) The printing plate material for direct plate making according to (1), wherein the hydrophilic layer is silicate-treated.

(5) The printing plate material for direct plate making according to one of (1) to (4), wherein the hydrophilic layer has an average thickness of between 0.01 μm and 1 μm, inclusively.

(6) The printing plate material for direct plate making according to one of (1) to (5), wherein the dot control layer is water-soluble.

(7) The printing plate material for direct plate making according to one of (1) to (6), wherein a contact angle of the dot control layer and the image forming liquid is between 30 degrees and 70 degrees, inclusively.

(8) The printing plate material for direct plate making according to one of (1) to (7), wherein the dot control layer includes an aqueous surfactant having a surface tension of 20 mN/m or lower at a temperature of 25 degrees Celsius in a water solution of 0.1% by weight.

(9) The printing plate material for direct plate making according to one of (1) to (8), wherein the dot control layer includes a fluorosurfactant.

(10) The printing plate material for direct plate making according to one of (1) to (9), wherein a surface of the aluminum base material is roughened by machine polishing with an irregular abrasive.

(11) The printing plate material for direct plate making according to one of (1) to (10), wherein the surface of the aluminum base material is roughened by chemical treatment with one of an acid and an alkali.

(12) The printing plate material for direct plate making according to one of (1) to (11), wherein the surface of the aluminum base material is alumite-treated after having been roughened.

(13) The printing plate material for direct plate making according to one of (1) to (12), wherein a surface of the printing plate material for direct plate making has a surface roughness parameter Ry defined in JIS B0601: 1994 of between 8 μm and 12 μm, inclusively, and an average roughness parameter Ra defined in JIS B0601: 1994 of between 1 μm and 2 μm, inclusively.

(14) The printing plate material for direct plate making according to (13), further including an alumite-treated layer being formed by alumite treatment on a surface of the base material after having been roughened, wherein the surface of the printing plate material for direct plate making has a surface roughness parameter Ry defined in JIS B0601: 1994 of between 8 μm and 12 μm, inclusively, and an average roughness parameter Ra defined in JIS B0601: 1994 of between 1 μm and 2 μm, inclusively; and the alumite-treated layer has a thickness of between 0.1 μm and 1 μm, inclusively.

(15) The printing plate material for direct plate making according to one of (1) to (12), wherein the surface of the printing plate material for direct plate making has a surface roughness parameter Ry defined in JIS B0601: 1994 of between 1 μm and 4 μm, inclusively, and an average roughness parameter Ra defined in JIS B0601: 1994 of between 0.1 μm and 1 μm, inclusively.

(16) The printing plate material for direct plate making according to (15), further including an alumite-treated layer being formed by alumite treatment on a surface of the base material after having been roughened, wherein the surface of the printing plate material for direct plate making has a surface roughness parameter Ry defined in JIS B0601: 1994 of between 1 μm and 4 μm, inclusively, and an average roughness parameter Ra defined in JIS B0601: 1994 of between 0.1 μm and 1 μm, inclusively; and the alumite-treated layer has a thickness of between 1 μm and 16 μm, inclusively.

(17) The printing plate material for direct plate making according to one of (12), (15), and (16), wherein the alumite treatment is alumite phosphate treatment; and the alumite-treated layer has a thickness of between 1 μm and 4 μm, inclusively.

(18) The printing plate material for direct plate making according to one of (12), (15), and (16), wherein the alumite treatment is alumite sulfate treatment; and the alumite-treated layer has a thickness of between 10 μm and 16 μm, inclusively.

Further, the above-described purpose is achieved in a manufacturing method of the printing plate material for direct plate making described below in (19) to (21).

(19) A manufacturing method of the printing plate material for direct plate making according to one of (1) to (18), the manufacturing method including a process for forming a hydrophilic layer on a roughened surface of an aluminum base material and a process for forming a dot control layer on a surface of the hydrophilic layer.

(20) A manufacturing method of the printing plate material for direct plate making according to one of (2), (3), and (5) to (18), the manufacturing method including a process for forming a layer including a photocatalyst on a roughened surface of an aluminum base material, the photocatalyst inducing hydrophilization when being exposed to an active light, and subsequently for exposing the layer to the active light for hydrophilization; and a process for forming a dot control layer on a surface of the hydrophilic layer.

(21) The manufacturing method of the printing plate material for direct plate making according to one of (19) and (20), wherein the dot control layer is formed by drying a coating film of an aqueous surfactant solution of between 0.2% by weight and 0.8% by weight, inclusively.

Further, the above-described purpose is achieved in a method for making a direct-made printing plate described below in (22) to (24).

(22) A method for making a direct-made printing plate using a printing plate material for direct plate making, the plate-making method including a process for discharging an image forming liquid on a surface of a dot control layer of the printing plate material for direct plate making according to (1), and a process for hardening the image forming liquid by one of exposing the image forming liquid to an active light and heating the image forming liquid.

(23) A method for making a direct-made printing plate using a printing plate material for direct plate making, the plate-making method including a process for discharging an image forming liquid including a photo-polymerized resin on a surface of a dot control layer of the printing plate material for direct plate making according to (2), and a process for hardening the image forming liquid by exposing the image forming liquid to a first active light, and, at the same time, for hydrophilizing a hydrophilic layer containing a photocatalyst by exposing the layer to a second active light.

(24) A method for making a printing plate using the printing plate material according to (23), the plate-making method including discharging the image forming liquid being composed of a photo-polymerized resin, on a surface of the dot control layer; hardening the image forming liquid by exposing the image forming liquid to an active light; and hydrophilizing a hydrophilic layer containing a photocatalyst by exposing the layer to the active light.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a structure of a printing plate material for direct plate making used in the present invention;

FIG. 2 illustrates a plate-making method using the printing plate material for direct plate making according to the present invention; and

FIG. 3 illustrates a plate-making method using the printing plate material for direct plate making according to the present invention.

### DETAILED DESCRIPTION OF PREFERRED EMBODIMENTS

The embodiments of the present invention are explained in the following, with reference to the above-described drawings. A direct-made printing plate according to the embodiments of the present invention is an offset printing plate made directly from a draft without using a prepress film. A printing plate material for direct plate making according to the embodiments of the present invention is a printing plate on which no image portion has been formed. In other words, forming an image portion on the printing plate material for direct plate making makes the direct-made printing plate. A process for making the direct-made printing plate is referred to as plate-making.

Performance of the direct-made printing plate made as described above is determined based on a shape, peeling, and wear resistance of a dot (an ink droplet) of an image forming liquid for forming an image portion formed on a surface of the printing plate material for direct plate making in the plate-making process; dampening water retainability on a non-image portion; wear resistance on a surface of the non-image portion; and the like. Resolution of the direct-made printing plate is mainly affected by the shape (a diameter) of the dot (the ink droplet). Printing durability of the direct-made printing plate is mainly affected by the dot shape (height), peeling (adhesion), and wear resistance. Further, printability of the direct-made printing plate is mainly affected by the dampening water retainability on the non-image portion and the wear resistance on the non-image portion surface.

1. A printing plate material for direct plate making:

An aluminum base material used for the printing plate material for direct plate making according to the present invention includes pure aluminum (e.g., AA1050). A surface of the printing plate material for direct plate making of the present invention may be roughened. Surface roughness affects a shape and adhesion of a dot of an image forming liquid (hereinafter described) formed on the printing plate material for direct plate making, and a pressure exerted on the dot during printing. The surface roughness thus affects resolution and printing durability of a direct-made printing plate. The effects of the surface roughness are described below. The dot means an ink droplet of an discharged image forming liquid formed on the printing plate material for direct plate making.

Described first is a relationship between the surface roughness of the printing plate material for direct plate making and the dot shape. Since the printing plate material for direct plate making has an uneven surface having a minute intrusion and extrusion formed thereon, an attached image forming liquid tends to spread along the unevenness due to capillary action. Thereby, the image forming liquid permeates in substantially a vertical direction with respect to the printing plate material for direct plate making, that is, in a depth direction, before spreading in a horizontal direction with respect to the printing plate material for direct plate making. The dot thus appears having a clear round shape from a top view of the printing plate material for direct plate making. The dot is prevented from spreading, thus improving the resolution of the printing plate. Further, the image forming liquid adheres thinly to an extruded portion and thickly to an intruded portion on the surface. Thus, the dot of the image forming liquid formed on the printing plate material for direct plate making has substantially a flat shape slightly protruding from the printing plate material for direct plate making from a side view of the printing plate material. Such a dot shape reduces a force exerted on an image portion during printing, thus improving printability.

Described next is a relationship between the surface roughness of the printing plate material for direct plate making and the dot adhesion. The adhesion between the dot and the printing plate material for direct plate making is determined by 1) adhesion between the aluminum base material and a hydrophilic layer (hereinafter described); 2) adhesion between the hydrophilic layer and a dot control layer (hereinafter described); and 3) adhesion between the dot control layer and an image forming liquid (hereinafter described). An additional factor that contributes to the adhesion of the dot and the printing plate material is the unevenness on the printing plate material surface for direct plate printing. When it is assumed that the adhesion is not affected by the surface unevenness, the adhesion of the dot and the printing plate material for direct plate making should remain the same, as long as a combination of the hydrophilic layer, the dot control layer, and the image forming liquid is the same, and thus the adhesion described in 1) to 3) is the same, even though the surface unevenness changes. When the surface unevenness of the printing plate material for direct plate making changes, however, the adhesion differs. The difference occurs since an anchor effect varies depending on the surface unevenness. More specifically, when the unevenness becomes large, an adhesion area in the same surface area widens, thus increasing the adhesion.

The printing plate material for direct plate making includes the aluminum base material, the hydrophilic layer, and the dot control layer. The hydrophilic layer and the dot control layer are thin enough to have no impact to the surface roughness. Thereby, it is acceptable to consider that the surface roughness of the printing plate material for direct plate making is the surface roughness of the aluminum base material. It is therefore preferable to roughen the aluminum base material in order to roughen the printing plate material for direct plate making.

A method for roughening the aluminum base material includes machine polishing using an irregular abrasive. The irregular abrasive is an abrasive having a random and uneven shape, compared to a round-shaped glass bead. Machine polishing is a polishing method in which, for example, an abrasive, such as an abrasive grain and the like, is physically rubbed on a surface to be polished, by spraying the abrasive along with air on the treatment surface from a spray gun. Machine polishing using the irregular abrasive is suitable, since the surface can be processed into a complex shape. Polishing using the glass bead having a regular round shape shapes the surface into a cup shape. Thus, the adhesion of the image forming liquid attached to the surface is insufficient because the anchor effect is different, even though a parameter indicating surface roughness is at the same level. Further, an optimum grain size of the abrasive is selected based on a treatment time and pressure. For instance, an irregular abrasive supplied by Fuji Manufactory Co., Ltd., such as Fujilundum WA #220 and the like, can be sprayed from a blast gun onto an aluminum plate surface along with compressed air of 0.2 MPa to 0.5 MPa.

In addition, a method for processing the aluminum surface to provide a complex and rough shape thereon includes chemical treatment using an acid or an alkali. The chemical treatment using the acid or alkali is a roughening method in which the chemicals are used to etch the aluminum surface. An example method is to use a satin agent for aluminum (an acid type or an alkaline type) as a chemical treatment solution and to control roughness depending on a treatment temperature and a treatment time.

Machine polishing using the irregular abrasive does not use chemicals, such as an acid, an alkali, and the like, and thus allows safe processing. Machine polishing has a further advantage as an environmental measure to reduce environmental burden, since the method does not require disposal and storage of a treatment solution. On the other hand, roughening with the chemical treatment causes no mechanical stress to the aluminum plate. The chemical treatment has an advantage of reducing cost, because, unlike machine processing, it is not required to perform an equal process on both sides of the aluminum plate to avoid bending, for example. Either of the above-described two roughening methods can be employed. Further, the both methods may be used together. Any roughening technique, such as brush polishing and the like, may further be used, as far as the processing method can achieve a target surface roughness parameter and shape.

The surface roughness of the printing plate material for direct plate making roughened as above is properly controlled based on the shape and adhesion of the dot of the discharged image forming liquid formed on the printing plate material surface.

When the surface roughness of the printing plate material for direct plate making is controlled in a relatively narrow range, a preferable range of Ry is between 1 μm and 4 μm, inclusively, and that of Ra is between 0.1 μm and 1 μm, inclusively, Ry being a maximum depth as defined in JIS B0601 (1994), Ra being arithmetic average roughness as defined in JIS B0601 (1994). A more preferable range of Ry is between 2 μm and 3.5 μm, inclusively, and that of Ra is between 0.2 μm and 0.5 μm, inclusively. As described hereinafter, combining with alumite treatment of the aluminum base material surface provides particularly good shape and adhesion of the dot of the image forming liquid.

When the surface roughness of the printing plate material for direct plate making is controlled in a relatively wide range, a preferable range of Ry is between 8 μm and 12 μm, inclusively, and that of Ra is between 1 μm and 2 μm, inclusively. A more preferable range of Ry is between 9 μm and 10 μm, inclusively, and that of Ra is between 1 μm and 1.5 μm, inclusively. Thereby, the shape and adhesion of the dot of the image forming liquid discharged on the printing plate material surface is good. Particularly, a great Ry value functions as a spacer when an ink roller and the like and the printing plate contact during printing, thus reducing a force exerted on the dot.

However, preferable surface roughness slightly changes depending on an ink droplet amount discharged from an inkjet recording head. For low-resolution recording, for instance, the ink droplet amount discharged from the inkjet recording head is large. Thus, the roughness parameters Ry and Ra need to be greater so as to reduce protrusion of the dot. On the other hand, for high-resolution recording, the ink droplet amount is small, and thus the roughness parameters Ry and Ra become less. As described above, the range of the surface roughness may be appropriately changed according to the ink droplet amount discharged from the inkjet recording head.

Further, the roughened surface of the aluminum base material may be alumite-treated. The alumite treatment increases surface hardness of the roughened printing plate material for direct plate making. Improving the surface hardness reduces wear in an extruded portion on the surface. The wear occurs when a blanket, an ink roller, and the like contact the printing plate material for direct plate making during printing. Dampening water retainability, which declines when the unevenness on a non-image portion becomes small, can be prevented from declining.

A thickness of the alumite-treated layer may be set up to about 50 μm. In terms of cost and the like, however, it is preferable to set the thickness to a range of between 0.1 μm and 20 μm, inclusively. Particularly, when the thickness of the alumite layer exceeds 4 μm, the alumite layer becomes porous. Then, the hydrophilic layer penetrates into fine pores in the porous layer. The anchor effect thereby provides an advantage where the adhesion eventually improves between the image forming liquid and the printing plate material for direct plate making. The alumite treatment includes alumite phosphate treatment, in which aluminum is anodized in a phosphate solution; and alumite sulfate treatment, in which aluminum is anodized in a sulfate solution.

The thickness of the alumite-treated layer is appropriately controlled in relation with the surface roughness of the printing plate material for direct plate making, which is described below.

1) When the surface roughness of the printing plate material for direct plate making is relatively small:

More specifically, when the range of Ry is between 1 μm and 4 μm, inclusively, and that of Ra is between 0.1 μm and 1 μm, inclusively, a preferable thickness of the alumite layer is between 1 μm and 16 μm, inclusively. Since the surface unevenness of the printing plate material for direct plate making is relatively small, the alumite layer having a certain thickness provides the anchor effect due to fine pores, thus increasing the adhesion of the image forming liquid to the printing plate material for direct plate making.

Performing the alumite phosphate treatment when providing the alumite layer further increases the adhesion between phosphate and the hydrophilic layer. Thereby, even a relatively thin alumite layer has an increased adhesion of the image forming liquid to the printing plate material for direct plate making. Thus, it is preferable to provide the alumite-treated layer with a thickness of 1 μm and 4 μm, inclusively, when performing the alumite phosphate treatment. The effect is more notable when titanium oxide and an inorganic coating agent are used for the hydrophilic layer, since affinity between the inorganic coating agent and phosphate is higher.

On the other hand, when forming a thick alumite layer, the alumite sulfate treatment is suitable since the treatment allows a high-speed process at an affordable cost. Thus, it is preferable to provide the alumite-treated layer with a thickness of 10 μm and 16 μm, inclusively, when performing the sulfate phosphate treatment.

2) When the surface roughness of the printing plate material for direct plate making is relatively large:

More specifically, when the range of Ry is between 8 μm and 12 μm, inclusively, and that of Ra is between 1 μm and 2 μm, inclusively, a preferable thickness of the alumite layer is between 0.1 μm and 1 μm, inclusively. The alumite layer having such a thickness is not porous, and thus the anchor effect is not sufficient for adhesion to the hydrophilic layer. However, relatively large surface unevenness of the printing plate material for direct plate making eventually increases the adhesion of the image forming liquid to the printing plate material for direct plate making and provides sufficient protection to the aluminum base material. In this case, either the alumite phosphate treatment or alumite sulfate treatment can be performed to provide the alumite layer.

The printing plate material for direct plate making of the present invention has the hydrophilic layer provided on the aluminum base material. The hydrophilic layer, which is provided in order to increase dampening water retainability during printing, is not limited as far as the layer has affinity for water. It is preferable, however, that the layer have a critical surface tension of 50 mN/m or higher, so as to maintain a good dampening water retainability during printing.

The hydrophilic layer can be formed of a photocatalyst that induces hydrophilization when being exposed to an active light. Described below is a case where the photocatalyst that induces hydrophilization when being exposed to the active light is used to form the hydrophilic layer (hereinafter referred to as a “photocatalytic hydrophilic layer”). The active light is a light that has a light emitting line in a wavelength range to which the photocatalyst is sensitive. Hydrophilization is an effect to increase affinity for water as the catalyst is exposed to the active light and thus a hydrophilic group is provided on a surface. Examples of the photocatalyst include titanium oxide, zinc oxide, and the like. The titanium oxide is preferable among others in terms of a level of photocatalytic performance.

In order to maintain mechanical strength of the photocatalytic hydrophilic layer, the titanium oxide and inorganic coating agent may be used together. Further, the photocatalytic hydrophilic layer may also contain a metal fluoride filler coated by silica.

The inorganic coating agent is a coating agent that contains a hydrolytic substance as a matrix, the hydrolytic substance being derived from hydrolysis of a hydrolytic organosilane, which is represented as a chemical formula of SiX₄ (X: a hydrolysis group). The inorganic coating agent has a characteristic of forming a porous matrix. The characteristic of forming the porous matrix means a characteristic where the inorganic coating agent dissolved in water, an organic solvent, or the like is applied to a base material, and, when dried, the agent forms a porous coating film that contains minute pores. The pores formed herein may be independently existing cells or interconnected cells. The photocatalytic hydrophilic layer may have a structure where titanium oxide is dispersed in the inorganic coating agent. An example of a material having such a structure is “Frescera-P” of Matsushita Electric Works, Ltd. and the like.

The inorganic coating agent that contains the titanium oxide is preferable since the agent can form a hydrophilic layer when being applied to a base material and dried. The agent is also excellent in life length, since the matrix is not decomposed when subject to a catalytic function of the titanium oxide.

The photocatalytic hydrophilic layer may be provided with a matrix in which the titanium oxide is dispersed, the matrix having a high binding energy and being unaffected by the catalytic function of the titanium oxide.

The titanium oxide includes an anatase type and a rutile type, either of which may be used, though the anatase-type titanium oxide is preferable. To further increase the photocatalytic performance, a preferable average grain size of the titanium oxide is 20 nm or smaller.

A preferable coating film thickness of the inorganic coating agent is between 0.01 μm and 1 μm, inclusively, so as not to fill the uneven surface of the printing plate material for direct plate making. To prevent a crack, a preferable thickness is between 0.01 μm and 0.5 μm, inclusively.

The photocatalytic hydrophilic layer obtained as described above has a contact angle of substantially 0 degrees with respect to water, thus providing an extremely good hydrophilic property. When the hydrophilic property declines, the photocatalytic hydrophilic layer can regain the property by reacting to ultraviolet that works as an active light. Using a ultraviolet hardening resin as the image forming liquid allows re-hydrophilization of the photocatalytic hydrophilic layer when being exposed to ultraviolet, which is irradiated in an image forming process for hardening the resin so as to form an image portion, thereby preventing a trouble during printing caused by a hydrophilic failure.

A conventional printing plate having a silicate-treated aluminum base material (a PS plate) requires a printing plate material to have a small surface roughness, that is, an arithmetic average roughness Ra of substantially 0.3 μm to 1 μm, in order to achieve an appropriate dampening water property. This is because increasing the surface roughness increases the contact angle of a non-image portion and dampening water, thus resulting in a decline in dampening water retainability. However, using a photocatalyst, such as titanium oxide, which induces hydrophilization when reacting to an active light, achieves substantially a high hydrophilic property as described above. Thereby, the water contact angle does not become large, even when the surface roughness of the printing plate material is larger than the conventional level, thus providing a good dampening water retainability.

Further, in the present invention, the hydrophilic layer may be formed by silicate-treating an the aluminum base material surface. For the silicate treatment, a method can be employed in which the aluminum base material is immersed in a sodium silicate solution. Although the surface roughness of the printing plate material for direct plate making is restricted to some extent as described above, the silicate treatment has an advantage of providing a hydrophilic layer without a treatment for hydrophilization, such as irradiation of an active light and the like. Further, a hydrophilic material other than described above may be used to form the hydrophilic layer.

The printing plate material for direct plate making of the present invention has the dot control layer provided on the hydrophilic layer. The dot control layer is a layer provided in order to control a shape of the dot. The dot control layer is not limited, as far as the layer has a critical surface tension equal to or lower than a surface tension of an image forming liquid hereinafter described. The critical surface tension of a solid object according to the present invention is measured in a commonly-called Zisman plot method (refer to Kondo, Masatoshi, et al. 2005. Surface Chemistry. p. 189. Maruzen) wherein: 1) a plurality of liquids are prepared, whose surface tensions at a temperature of 25 degree Celsius are known; 2) a contact angle of each of the liquids and the dot control layer surface is measured at a temperature of 25 degrees Celsius; 3) a relationship between each of the surface tensions and the contact angle is plotted; and 4) a value having a contact angle of 0 is inserted.

The dot control layer can be formed by applying a surfactant, a block copolymer, or a block oligomer to a base material. The surfactant is a substance having hydrophilic and hydrophobic portions in a molecule. The block copolymer herein means a polymer having both hydrophilic and hydrophobic portions in a molecule. The block oligomer means a block copolymer having a small quantity of molecules. The dot control layer may be formed by dissolving one of the substances above in a solvent and applying the dissolved substance, but the surfactant is preferable in terms of workability in application.

Further, the dot control layer needs to be removed from a non-image portion, in order to ensure dampening water retainability during printing. The dot control layer may be removed by using a solvent that dissolves the dot control layer, such as, an organic solvent, water, and an organic solvent mixed with water. It is preferable to use water as a solvent since water can easily remove the dot control layer, and further dampening water used during printing can be used for the removal. Therefore, it is preferable that the dot control layer be water-soluble. An aqueous surfactant has a good affinity for the hydrophilic layer, thus providing an advantage of forming an even dot control layer without irregularity. It is preferable to use an aqueous surfactant having a surface tension of 20 mN/m or lower in a water solution of 0.1% by weight, since such a surfactant enables the dot control layer to have a critical surface tension of lower than 30 mN/m and allows easy removal of the dot control layer due to its water solubility.

Examples of the above-described surfactant include a fluorosurfactant having an alkyl fluoride group, a hydrocarbon surfactant having an alkyl group, and the like. Since the image forming liquid is generally lipophilic, however, it is preferable that the surface tension of the dot control layer not only be hydrophobic but lipophobic. Thus, the fluorosurfactant is particularly preferable since the surfactant is capable of forming a layer having a lower surface tension. An example of the fluorosurfactant includes “Surfron” manufactured by Seimi Chemical Co., Ltd., the surfactant having a surface tension of 17 mN/m in a water solution of 0.1% by weight.

As described above, the dot control layer provided on the printing plate material for direct plate making allows the image forming liquid discharged during plate-making to adhere to the printing plate material having a large contact angle, and allows the dot to hold a small dome shape without spreading. Thereby, the direct-made printing plate according to the present invention is capable of maintaining high resolution. In order to provide good adhesion of the image forming liquid to the printing plate material for direct plate making, however, it is preferable that the printing plate material surface have an appropriate wettability with respect to the image forming liquid. In order for the image forming liquid not to spread and to maintain adhesion, a preferable critical surface tension of the dot control layer is between 30% and 95%, inclusively, of the surface tension of the image forming liquid; a more preferable critical surface tension is between 30% and 90%, inclusively; and a further more preferable critical surface tension is between 50% and 80%, inclusively. For instance, when a ultraviolet hardening resin having a surface tension of substantially 34 mN/m is used as the image forming liquid, a balance between the dot shape and adhesion is particularly excellent with the critical surface tension of the dot control layer of substantially 20 mN/m. A preferable contact angle of the image forming liquid with respect to the printing plate material surface is between 20 degrees to 70 degrees, inclusively; a more preferable contact angle is between 30 degrees and 70 degrees, inclusively; and a further more preferable contact angle is between 40 degrees and 65 degrees, inclusively. Depending on a surface condition and the like, however, the surface tension range does not need to be as described above.

2. A manufacturing method of the printing plate material for direct plate making: Although any preferred method may be employed for manufacturing the printing plate material for direct plate making without affecting the effectiveness of the present invention, a preferable method is described below. The printing plate material for direct plate making of the present invention is basically manufactured in processes for forming a hydrophilic layer on a surface of an aluminum base material and for forming a dot control layer on the hydrophilic layer. The surface of the aluminum base material used in the present invention may be roughened and alumite-treated.

A photocatalytic hydrophilic layer can be formed as the hydrophilic layer on the aluminum base material surface, by applying and drying a matrix having a high binding energy, being unaffected by a catalytic function of a photocatalyst, and being provided with a dispersed photocatalyst. It is particularly preferable to use an inorganic coating agent in which titanium oxide is dispersed because the agent provides excellent workability and photocatalytic performance.

The photocatalytic hydrophilic layer can be hydrophilized when being exposed to an active light, but hydrophilization may be performed at any stage. For example, hydrophilizing the photocatalytic hydrophilic layer before providing the dot control layer provides a good affinity for a surfactant, thus allowing an even dot layer to be provided when the dot layer is formed by using an aqueous surfactant. When manufacturing needs to be suspended and the provided photocatalytic hydrophilic layer needs to be stored for a while for a certain reason prior to being exposed to the active light for hydrophilization, hydrophilization may be performed when manufacturing resumes. When the hydrophilic property of the hydrophilic layer declines after having been hydrophilized and stored for a while, hydrophilization may be performed again when manufacturing resumes. When the dot control layer is formed by using a non-aqueous surfactant, a block polymer, or a block oligomer, it is advantageous to hydrophilize the photocatalytic hydrophilic layer after providing the dot control layer. This is because the photocatalytic hydrophilic layer before hydrophilization has a good affinity for the non-aqueous surfactant and the like, thus capable of providing an even dot control layer.

Silicate treatment may also be performed when providing the hydrophilic layer of the present invention. For instance, immersing the aluminum base material into a sodium silicate solution provides the hydrophilic layer.

When forming the dot control layer on the hydrophilic layer surface, it is preferable to apply and dry a solvent in which a surfactant, a block polymer, or a block oligomer is dissolved. Using water as the solvent eliminates such a problem as evaporation of an organic solvent and the like, and provides high workability. It is thus preferable to apply the surfactant and the like in a form of a water solution. Further, given solubility in water and viscosity of the solution, it is preferable to use a lower-molecular surfactant. Therefore, it is preferable that the dot control layer be formed by applying and drying an aqueous surfactant.

A preferable concentration of the surfactant solution is between 0.1% by weight and 0.9% by weight, inclusively; a more preferable concentration is between 0.2% by weight and 0.8% by weight, inclusively; and a further more preferable concentration is between 0.4% by weight and 0.6% by weight, inclusively. When the concentration of the solution is lower than 0.1% by weight, the dot control layer surface has a insufficient concentration of a hydrophobic group, and thus the critical surface tension of the dot control layer is not low enough. On the other hand, when the concentration of the solution exceeds 1.0% by weight, an excessive surfactant dissolves in dampening water, thereby causing a problem of decline in a dampening water function.

The manufacturing method of the present invention can provide the printing plate material for direct plate making which is excellent in printability represented as printing durability and dampening water retainability.

3. The direct-made printing plate of the present invention:

The direct-made printing plate can be obtained through a plate-making process, in which an image forming liquid is discharged on a surface of the above-described printing plate material for direct plate making and an ink droplet is hardened so as to form an image. The image forming liquid used in the present invention is a liquid having a liquid form when being discharged, being solidified thereafter in a hardening reaction, and forming an image portion. Examples of such an image forming liquid include a photopolymerized resin, a thermoset resin, and the like. The photopolymerized resin is a compound which is polymerized when being exposed to an active light. The photopolymerized resin may include a photopolymerized material, such as a photo-initiator, a booster, and the like; a color material; and a solvent. The photopolymerized resin is also referred to as a photo-hardening resin. The photopolymerized resin is a mixture of a high-viscosity oligomer and a low-viscosity oligomer or monomer, which is referred to as a reactive reducer. Viscosity of the photopolymerized resin may be controlled according to a mixing ratio. The active light is a light having a light emitting line in a wavelength range to which the resin is sensitive. A ultraviolet hardening resin, to which ultraviolet works as the active light, is particularly preferable in terms of hardening performance and workability. Specific examples of such resin include a polyester acrylate, an epoxy acrylate, a urethane acrylate, and the like.

The photo-initiator is an agent that generates a radical in reaction to the active light, reacts to a photopolymerized functional group of a monomer or oligomer, and then initiates polymerization. The agent using ultraviolet as the active light is preferable from the above-described reasons.

Further, the photopolymerized resin may include a pigment or a dye as the color material so as to allow easy inspection of a plate after plate-making. The color material is added in a state dissolved in a solvent selected from, such as a hydrocarbon, an alcohol, a ketone, an ether alcohol, an ether, an ester, and the like. The color material has a different ultraviolet absorbing property depending on a hue, and thus substantially affects a hardening property of the ultraviolet hardening resin. It is therefore preferable to select a color material that provides high visibility and minimizes an impact on the hardening property. Further, it is necessary to select a color material that does not adversely impact storage stability of the ultraviolet hardening resin (e.g., does not gelate the resin) and that is not affected by monomer decomposition.

The thermoset resin is a resin that does not harden at room temperature and hardens when being heated. The resin is selected from, such as acrylic, epoxy, and amino-alkyd resins, and a urethane resin using a block isocyanate resin. The thermoset resin hardens in a crosslinking reaction of functional groups of molecules. From a workability viewpoint, it is preferable that the hardening reaction be performed at a temperature range of 120 degrees to 180 degrees.

Although the surface tension of the image forming liquid is not particularly specified, a preferable surface tension is between 30 mN/m to 40 mN/m, so as to allow high-speed and stable forming of an ink droplet supplied from an inkjet recording head. The surface tension of the liquid defined in the present invention can be measured at a temperature of 25 degrees Celsius using contact angle measuring equipment Drop Master 500 manufactured by Kyowa Interface Science Co. The measuring equipment measures a value of static surface tension in a pendant drop method, wherein an ink droplet image is obtained immediately before an ink droplet drops from a needlepoint and the surface tension is calculated based on the obtained image and liquid density. More specifically, the measuring equipment automatically measures a maximum radius (d) of a pendant drop hanging from the needlepoint, and then calculates the value using surface tension analyzing software (PD-V type).

A preferable viscosity of the image forming liquid is 30 cps or lower, so as to allow high-speed and stable forming of the ink droplet (the dot) supplied from the inkjet recording head. A more preferable viscosity is between 8 cps and 20 cps, inclusively. An example of such an image forming liquid is a ultraviolet hardening resin of a polyester acrylate type having a surface tension of substantially 34 mN/m. The inkjet recording head may be heated so as to control the image forming liquid to meet the above-described conditions.

4. A method for making a printing plate:

Although any preferred method may be employed for making a direct-made printing plate without affecting the effectiveness of the present invention, a preferable method is described below. A printing plate is made by discharging and hardening an image forming liquid on the printing plate material of the present invention, so as to form an image portion. Discharging means spraying the liquid in a form of an ink droplet and attaching the ink droplet to the printing plate material. It is preferable to use an inkjet recording head for discharge. As the image forming liquid, a photopolymerized resin that hardens when being exposed to an active light is preferable, as described above. Particularly preferable is a ultraviolet hardening resin whose active light is ultraviolet. Hardening is a reaction where the active light generates an active species, such as a radical, which reacts to a functional group of the resin and increases a quantity of molecules. When the photopolymerized resin is employed, exposing the discharged liquid to the active light for hardening forms a reinforced image portion.

When the printing plate material for direct plate making has a photocatalytic hydrophilic layer, the photocatalytic hydrophilic layer may be hydrophilized when being exposed to the active light during plate-making. Such a printing plate material has an advantage when the printing plate material for direct plate making is stored for a long period of time after having been manufactured, since the hydrophilic property may decline even though the photocatalytic hydrophilic layer was once hydrophilized. Such a printing plate material has a further advantage of simplifying a process when the photocatalytic hydrophilic layer of the printing plate material for direct plate making is manufactured without being hydrophilized, since the plate-making process allows hydrophilization of the photocatalytic hydrophilic layer. Particularly, using the ultraviolet hardening resin as the image forming liquid allows hydrophilization along with a hardening process thereof, thus providing a stable hydrophilic property.

In the case above, the active light for hydrophilizing the photocatalytic hydrophilic layer and the active light for hardening the photo-hardening resin may be different. It is preferable, however, to use the same active light to simplify the manufacturing process. The same active light means an active light having a light emitting line that includes a wavelength range to which both the resin and photocatalyst are sensitive.

The method above can provide a high-resolution printing plate material for direct plate making which is excellent in printability represented as printing durability and dampening water retainability.

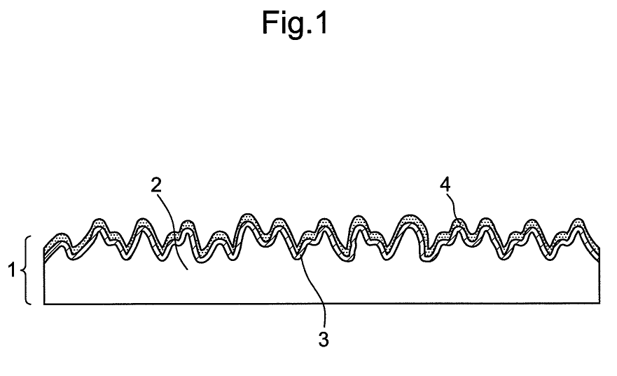

To explain the present invention in more detail, the embodiments of the present invention are explained below with reference to the drawings. The present invention, however, is not limited to the embodiments. FIG. 1 illustrates the printing plate material for direct plate making according to the present invention. Printing plate material for direct plate making 1 includes roughened aluminum base material 2; photocatalytic hydrophilic layer 3 that includes an inorganic coating agent and titanium oxide; and dot control layer 4 that includes an aqueous fluorosurfactant.

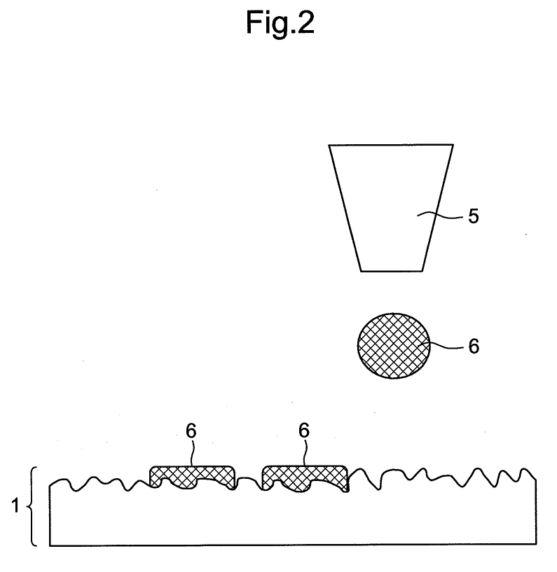

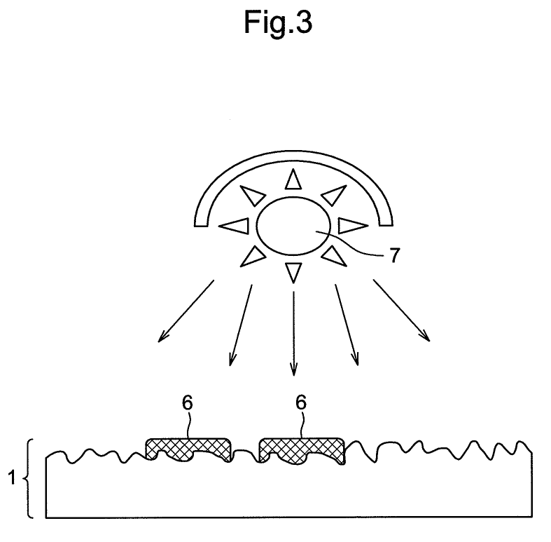

The method for making the printing plate using printing plate material for direct plate making 1 having the above structure is explained with reference to FIGS. 2 and 3. Shown in FIGS. 2 and 3 are printing plate material for direct plate making 1; inkjet recording head 5; ultraviolet hardening resin 6, which is an image forming liquid; and ultraviolet light source 7 that hardens the ultraviolet hardening resin adhering to the printing plate material for direct plate making. As shown in FIGS. 1 to 3, the present invention provides a relatively simple structure.

As shown in FIG. 2, ultraviolet hardening resin 6 in a form of an ink droplet is discharged to printing plate material for direct plate making 1 from inkjet recording head 5 based on data for forming an image portion. A control mechanism (not shown in the drawing) controls inkjet recording head 5 for the ink droplet discharge and a position of printing plate material for direct plate making 1, so as to form an image of ultraviolet hardening resin 6, which corresponds to an image portion in printing. Printing plate material for direct plate making 1, on which the image portion is formed of ultraviolet hardening resin 6, is exposed to ultraviolet light source 7. Resin 6 is then hardened, and a printing plate is made. Printing plate material for direct plate making 1 before being made as a printing plate has dot control layer 4 provided on photocatalytic hydrophilic layer 3, and ultraviolet hardening resin 6 is further attached to the image portion. Dampening water is supplied to printing plate material for direct plate making 1 during printing by a dampening water roller. Thin aqueous dot control layer 4 of a non-image portion dissolves in the dampening water and peels, thus exposing photocatalytic hydrophilic layer 3 underneath, which has a high hydrophilic property and thus a high dampening water retainability. Provided below are the embodiments of the present invention.

### First Embodiment

A product of Matsushita Electric Works, Ltd. “Frescera-P” is applied to and dried on a surface of aluminum base material 2, so as to provide photocatalytic hydrophilic layer 3. Then, photocatalytic hydrophilic layer 3 is exposed to a ultraviolet light having a wavelength of 350 nm to 400 nm for 3 minutes for hydrophilization, the ultraviolet light being irradiated from a ultraviolet light source (“P600S Series” manufactured by Fusion UV Systems, Inc.; an electrodeless UV lamp is used). Subsequently, the aluminum base material is dipped in and removed from a water solution of a fluorosurfactant (“Surfron” manufactured by Seimi Chemical Co., Ltd.), whose concentration is conditioned as shown in Table 1. The aluminum base material is then dried so as to provide dot control layer 4; and printing plate material for direct plate making 1 is obtained.

Onto a surface of obtained printing plate material 1, 0.5 cc of ultraviolet hardening resin 6 (a surface tension of substantially 34 mN/m) having a main component of a polyester acrylate polymer is dropped from a pipette, and then spread of an ink droplet is observed in 5 seconds. Table 1 below shows the results.

TABLE 1

| | | | | | | | |
|---|---|---|---|---|---|---|---|
| Concentration of | 1.00 | 0.80 | 0.60 | 0.40 | 0.20 | 0.10 | 0.03 |
| fluorosurfactant water | | | | | | | |
| solution (% by weight) | | | | | | | |
| Spread width (mm) in | 1.09 | 1.54 | 1.69 | 1.61 | 2.05 | 2.16 | 2.9 |
| 5 seconds | | | | | | | |
| Contact angle | 63.1 | 60.6 | 62 | 52.6 | 33.8 | 22.9 | 11.9 |
| (degrees) in | | | | | | | |
| 5 seconds | | | | | | | |
| Dampening water | Good | Good | Good | Good | Good | Good | Good |
| retainability | | | | | | | |

Based on the spread of ultraviolet hardening resin 6 shown in Table 1, a preferable concentration of the fluorosurfactant is 0.1% or greater by weight. A hydrophilic group in the fluorosurfactant is aligned on an aluminum base material 2 side and a perfluoroalkyl group (e.g., a CF₃ group) therein is aligned on an opposite side of the aluminum base material. Thereby, fluorine atoms are aligned on the surface, and thus the surface tension is reduced. Density of the perfluoroalkyl group is considered to vary because of the surfactant concentration in the treatment solution. When the concentration of the fluorosurfactant is 1.0% or greater by weight, however, it is confirmed that a large quantity of the fluorosurfactant dissolved in the dampening water declines a dampening water function, despite a good dampening water property of printing plate material for direct plate making 1. An excessive fluorosurfactant unattached to the aluminum base material surface is dissolved into the dampening water during printing, thus causing a decline in the dampening water performance. A contact angle in five seconds after dropping of ultraviolet hardening resin 6 indicates that the dot spread is contained when the contact angle is between 20 degrees and 70 degrees, inclusively, for reduction of the ink droplet spread. The spread is further contained when the contact angle is between 30 degrees and 70 degrees, inclusively; and further more contained between 50 degrees and 65 degrees, inclusively.

### Second Embodiment

A product of Matsushita Electric Works, Ltd. “Frescera-P” is applied to and dried on the surface of aluminum base material 2, so as to provide photocatalytic hydrophilic layer 3. Then, similar to the First Embodiment, photocatalytic hydrophilic layer 3 is exposed to a ultraviolet light for hydrophilization. Subsequently, the aluminum base material is dipped in and removed from a water solution of a fluorosurfactant (“Surfron” manufactured by Seimi Chemical Co., Ltd.) having 0.3% by weight. The aluminum base material is then dried so as to provide dot control layer 4; and printing plate material for direct plate making 1 is obtained.

Onto a surface of obtained printing plate material 1, 3-pl ultraviolet hardening resin 6 is discharged from an inkjet recording head, and exposed to ultraviolet immediately thereafter for hardening ultraviolet hardening resin 6. The spread of an ink droplet is then observed.

### COMPARATIVE EXAMPLE 1

Similar to the Second Embodiment, photocatalytic hydrophilic layer 3 is provided on the surface of aluminum base material 2, and then is hydrophilized. The spread of an ink droplet is then observed in a similar manner to the Second Embodiment. Table 2 below shows the results of the Second Embodiment and Comparison Example 1.

TABLE 2

| | Second | Comparison |
|---|---|---|
| | Embodiment | Example 1 |
| Dot control layer | Yes | No |
| Dot size (μm) | 23 | 57 |

As shown in Table 2, when the dot control layer is provided with the fluorosurfactant, a dot size of discharged ultraviolet hardening resin 6 is small. A calculated radius of the 3-pl ink droplet is about 18 μm, and the formed dot size is as small as about 1.3 times the radius. Namely, the spread is sufficiently contained even when the surfactant is discharged from the inkjet recording head. It is thus confirmed that a high-resolution image portion can be formed.

### Third Embodiment

The surface of aluminum base material 2 is degreased with a solvent, such as a trichloroethylene and the like, a surfactant, an alkaline water solution, and the like, in order to remove dirt or impurities from the surface. Then, an irregular abrasive (Fujilundum WA#220 manufactured by Fuji Manufactory Co., Ltd., or the like) is sprayed onto the surface from a blast gun along with compressed air of 0.2 MPa to 0.5 MPa, so as to roughen the surface. Then, the aluminum base material is obtained having a variety of surface roughness. Hydrophilic layer 3 and dot control layer 4 are provided on obtained aluminum base material 2 in the method described in the Second Embodiment, and then printing plate material for direct plate making 1 is obtained.

Subsequently, ultraviolet hardening resin 6 is discharged from an inkjet recording head in a form of a 3-pl ink droplet and attached to printing plate material for direct plate making 1 in the method described in the Second Embodiment; ultraviolet hardening resin 6 is exposed to ultraviolet having a wavelength of 350 nm to 400 nm so as to harden the ink droplet; and then a direct-made printing plate provided with a formed image is obtained. An assessment of dot adhesion and a dot shape of the printing plate is shown in Table 3.

TABLE 3

| | Ry | Ra | | | Dot size |
|---|---|---|---|---|---|
| | (μm) | (μm) | Peeling | Dot shape | (μm) |
| Third | 3.17 | 0.3 | Large | Fair (protrusion) | 25–30 |
| Embodiment | 6.09 | 0.58 | Medium | Fair (protrusion) | 20–25 |
| | 8.71 | 1.03 | Medium | Fair (protrusion) | 20–25 |
| | 9.24 | 1.21 | Negligible | Good | 20–25 |
| | 9.89 | 1.31 | Negligible | Good | 20–25 |
| | 14.17 | 1.88 | Most negligible | Poor (shape loss) | 25 |
| | 15.08 | 1.42 | Large | Poor (shape loss) | 25 |
| | 22.36 | 3.19 | Small | Poor (shape loss) | 25 |
| | 22.5 | 2.67 | Large | Poor (shape loss) | 25–30 |
| | 23.19 | 3.8 | Medium | Poor (shape loss) | 20 |
| | 38.5 | 4.66 | Large | Poor (shape loss) | 25–30 |
| Comparison | 3.04 | 0.38 | Large | | |
| Example 2 | | | | | |

The adhesion is confirmed by attaching and peeling an adhesive tape to and from an image (2 cm×2 cm) of ultraviolet hardening resin 6, which was discharged and hardened on printing plate material for direct plate making 1. The peeling test and actual printing test are performed separately and compared against each other. When a result of the peeling test is negligible or less, printing durability of a several ten thousand level is confirmed (i.e., no peeling occurs). The assessment is based on the confirmation method above. The dot shape is determined based on a level of the radial spread (loss of shape) due to the minute unevenness and a sinking level of ultraviolet hardening resin 6 on the uneven surface (whether dot protrusion is large or not). Table 3 shows that peeling is limited, which means the adhesion is good, when Ry (maximum depth) is between 9 μm and 14 μm, inclusively, and Ra (arithmetic average roughness) is between 1.0 μm and 1.4 μm, inclusively. Further, the table shows that the dot shape is good when Ry is between 9 μm and 10 μm, inclusively, and Ra is between 1.0 μm and 1.4 μm, inclusively. Ry works as a spacer when an ink roller or a blanket contacts during printing, and thus Ry can be expected to achieve an effect to reduce an ink roller pressure or a blanket pressure applied to ultraviolet hardening resin 6 that forms an image. To achieve such an effect, a greater Ry is preferable. It is confirmed, however, that the dot loses shape when Ry and Ra are too great; and that an adhesion area is reduced, thus easily causing peeling, when Ry and Ra are too little.

### COMPARATIVE EXAMPLE 2

Photocatalytic hydrophilic layer 3 and dot control layer 4 are provided on a surface of an aluminum base material (Ra of 0.38 μm; Ry of 3.04 μm), which is used as a base of a conventional PS plate and the like, in a similar manner to the Third Embodiment. A printing plate material is thus obtained for comparison. Similar to the Third Embodiment, an image provided with ultraviolet hardening resin 6 is formed on a surface of the printing plate material, and then a printing plate is obtained for comparison. The results of examined adhesion are shown in Table 3. As shown in Table 3, it is confirmed that the adhesion is inferior to the printing plate material for direct plate making of the present invention.

### Fourth Embodiment

Similar to a method used for a conventional PS plate, the surface of aluminum base material 2 is grained (details described hereinafter), and then aluminum base material 2 having a roughened surface is obtained. Aluminum base material 2 is anodized at a constant current in a sulfate water solution for an alumite-treatment of 4 μm to 17 μm (refer to Chemical Dictionary 7^{th} Edition. 2003. p. 80. Tokyo Kagaku Dozin Co., Ltd.). Hydrophilic layer 3 and dot control layer 4 are further provided on the base material 2 surface, in the method described in the First Embodiment, and printing plate material for direct plate making 1 is obtained.

The PS plate is grained in a procedure below. 1) An aluminum plate (Material 1050 and the like) is immersed in an aqueous sodium hydroxide for degreasing; a surface thereof is rinsed, and then polished with a nylon brush for roughening, while being poured over with an abrasive aqueous dispersion. 2) The surface is thoroughly washed with water; poured over with an alkaline solution (e.g., an aqueous sodium hydroxide); treated with chemical etching so as to remove the abrasive and aluminum flakes (desmutting); and then rinsed with running water. 3) The surface is electropolished with an acidic electrolyte at a three-phase current. 4) The surface is rinsed with water; poured over again with the alkaline water solution, so as to etch and remove a sharp edge on the aluminum surface (desumutting); and then further rinsed with water.

Ultraviolet hardening resin 6 is discharged from an inkjet recording head in a form of a 3-pl ink droplet and attached to obtained printing plate material for direct plate making 1 in the method described in the Second Embodiment; ultraviolet hardening resin 6 is exposed to ultraviolet having a wavelength of 350 nm to 400 nm for 4 seconds so as to harden the ink droplet; and then a direct-made printing plate is obtained. An assessment of dot adhesion and a dot shape of the printing plate is shown in Table 4.

TABLE 4

| Alumite | Ry | Ra | Alumite layer | | |
|---|---|---|---|---|---|
| treatment | (μm) | (μm) | thickness (μm) | Peeling | Dot shape |
| Alumite | 3.19 | 0.38 | 4 | Negligible | Good |
| phosphate | | | | | |
| Alumite | 3.19 | 0.38 | 4 | Peeling on | Good |
| sulfate | | | | entire surface | (protrusion) |
| | 3.36 | 0.34 | 15 | None | Good |
| | 2.90 | 0.38 | 16 | None | Good |
| | 3.26 | 0.32 | 17 | None | Good |

When the surface roughness of printing plate material for direct plate making 1 is relatively small, that is, Ra of 0.3 μm, thickening the alumite layer can improve the adhesion of ultraviolet hardening resin 6. It is considered that the anchor effect occurs notably since a minute pore of the alumite layer is deep. Meanwhile, the alumite phosphate treatment, which improves the adhesion to hydrophilic layer 3, can reduce the thickness of the alumite phosphate treated-layer, compared to an alumite sulfate treated-layer.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application Nos. 2006-080295 filed on Mar. 23, 2006 and 2006-285532 filed on Oct. 19, 2006, entire contents of which are expressly incorporated by reference herein.

What is claimed is:

1. A printing plate material on which an image forming liquid is discharged, the printing plate material comprising:
a base material;
a hydrophilic layer; and
a dot control layer, said hydrophilic layer being provided between said base material and said dot control layer and said dot control layer having a critical surface tension equal to or lower than a surface tension of the image forming liquid.

2. The printing plate material according to claim 1, wherein said base material comprises aluminum.

3. The printing plate material according to claim 2, wherein said hydrophilic layer comprises a photocatalyst that induces hydrophilization when being exposed to an light.

4. The printing plate material according to claim 2, wherein said hydrophilic layer comprises an inorganic coating agent and titanium oxide.

5. The printing plate material according to claim 2, wherein said hydrophilic layer is silicate-treated.

6. The printing plate material according to claim 2, wherein said hydrophilic layer has an average thickness in the range of about 0.01 μm to about 1 μm.

7. The printing plate material according to claim 2, wherein said dot control layer comprises a water-soluble material.

8. The printing plate material according to claim 2, wherein a contact angle of said dot control layer and the image forming liquid is in the range of about 30 degrees to about 70 degrees.

9. The printing plate material according to claim 2, wherein said dot control layer comprises an aqueous surfactant having a surface tension of 20 mN/m or lower at a temperature of 25 degrees Celsius in a water solution of 0.1% by weight.

10. The printing plate material according to claim 2, wherein said dot control layer comprises a fluorosurfactant.

11. The printing plate material according to claim 2, wherein a surface of said base material is roughened by machine polishing with an irregular abrasive.

12. The printing plate material according to claim 2, wherein a surface of said base material is roughened by chemical treatment with one of an acid and an alkali.

13. The printing plate material according to claim 2, wherein a surface of said base material is alumite-treated after having been roughened.

14. The printing plate material according to claim 2, wherein a surface of the printing plate material has a surface roughness parameter Ry defined in JIS B0601: 1994 in the range of about 8 μm to about 12 μm, and an average roughness parameter Ra defined in JIS B0601: 1994 in the range of about 1 μm to about 2 μm.

15. The printing plate material according to claim 2 further comprising an alumite-treated layer being formed by alumite treatment on a surface of said base material after having been roughened,
wherein the surface of the printing plate material has a surface roughness parameter Ry defined in JIS B0601: 1994 in the range of about 8 μm to about 12 μm, and an average roughness parameter Ra defined in JIS B0601: 1994 in the range of about 1 μm to about 2 μm and said alumite-treated layer has a thickness in the range of about 0.1 μm to about 1 μm.

16. The printing plate material according to claim 2, wherein the surface of the printing plate material has a surface roughness parameter Ry defined in JIS B0601: 1994 in the range of about 1 μm to about 4 μm, and an average roughness parameter Ra defined in JIS B0601: 1994 in the range of about 0.1 μm to about 1 μm.

17. The printing plate material according to claim 2 further comprising an alumite-treated layer being formed by alumite treatment on a surface of said base material after having been roughened,
wherein the surface of the printing plate material has a surface roughness parameter Ry defined in JIS B0601: 1994 in the range of about 1 μm to about 4 μm, and an average roughness parameter Ra defined in JIS B0601: 1994 in the range of about 0.1 μm to about 1 μm and said alumite-treated layer has a thickness in the range of about 1 μm to about 16 μm.

18. The printing plate material according to claim 17, wherein the alumite treatment is alumite phosphate treatment; and said alumite-treated layer has a thickness in the range of about 1 μm to about 4 μm.

19. The printing plate material according to claim 17, wherein the alumite treatment is alumite sulfate treatment; and said alumite-treated layer has a thickness in the range of about 10 μm to about 16 μm.

20. A manufacturing method of the printing plate material according to claim 1, the manufacturing method comprising:
forming the hydrophilic layer on a roughened surface of the base material; and
forming the dot control layer on a surface of said hydrophilic layer.

21. A manufacturing method of the printing plate material according to claim 3, the manufacturing method comprising:
forming the hydrophilic layer on a roughened surface of an aluminum base material;
exposing the hydrophilic layer to the light for hydrophilization; and
forming the dot control layer on a surface of the hydrophilic layer.

22. The manufacturing method of the printing plate material according to claim 20, wherein the dot control layer is formed by drying a coating film of an aqueous surfactant solution in the range of about 0.2% by weight to about 0.8% by weight.

23. A method for making a printing plate using the printing plate material according to claim 1, the plate-making method comprising:
discharging the image forming liquid on a surface of the dot control layer; and
hardening the image forming liquid by one of exposing the image forming liquid to an light and heating the image forming liquid.

24. A method for making a printing plate using the printing plate material according to claim 3, the plate-making method comprising:
discharging the image forming liquid being composed of a photo-polymerized resin, on a surface of the dot control layer; and
hardening the image forming liquid by exposing the image forming liquid to a first light, and hydrophilizing a hydrophilic layer containing a photocatalyst by exposing the layer to a second light.

25. A method for making a printing plate using the printing plate material according to claim 3, the plate-making method comprising:
discharging the image forming liquid being composed of a photo-polymerized resin, on a surface of the dot control layer; and
hardening the image forming liquid by exposing the image forming liquid to an light, and hydrophilizing a hydrophilic layer containing a photocatalyst by exposing the layer to the light.
